(19) United States
(12) Patent Application Publication
(10) Pub. No.: US 2026/0283189 A1
(43) Pub. Date: Sep. 24, 2026

(54) A NOVEL EMULSIFIER POWDER, METHOD OF ITS PRODUCTION AND RELATED USES AND PRODUCTS

(71) Applicant: PALSGAARD A/S, Juelsminde (DK)

(72) Inventors: Søren LORENZEN, Juelsminde (DK); Søren Albin JENSEN, Juelsminde (DK); Lars PREUSS, Juelsminde (DK)

(21) Appl. No.: 19/164,508

(22) PCT Filed: Mar. 21, 2024
(86) PCT No.: PCT/EP2024/057677

§ 371 Date: Sep. 11, 2025

(30) Foreign Application Priority Data
Mar. 22, 2023 (EP) 23163542.6

(51) Int. Cl. A23G 9/52; A23G 9/32; A23G 9/34

(52) U.S. Cl. CPC A23G 9/52; A23G 9/327; A23G 9/34

(57) ABSTRACT

The present invention pertains to a method of producing an emulsifier powder suitable for use in the production of cold process gelato. The method has an improved energy efficiency and comprises combining one or more emulsifier(s) and water-soluble particles comprising a saccharide under conditions that keep the water-soluble particle in solid form. The novel emulsifier powder has been found to have improved physical properties. The invention furthermore pertains to the emulsifier powder as well as uses and products thereof.

### FIELD OF THE INVENTION

The present invention pertains to a method of producing an emulsifier powder suitable for use in the production of cold process gelato. The method has an improved energy efficiency and comprises combining one or more emulsifier(s) and water-soluble particles comprising a saccharide under conditions that keep the water-soluble particle in solid form. The novel emulsifier powder has been found to have improved physical properties. The invention furthermore pertains to the emulsifier powder as well as uses and products thereof.

### BACKGROUND

Emulsifiers are frequently used in food industry, where they provide a number of benefits to the food products. In gelatos, a type of Italian ice cream, emulsifiers facilitate air incorporation and improve, e.g., fat emulsification, smoothness, creaminess, melting resistance, and heat-shock stability.

### SUMMARY OF THE INVENTION

The present inventors have discovered a new type of emulsifier products that are highly suitable for the production of gelato and similar food applications that require low temperature processing of the ingredients. The inventors have found that if the required emulsifiers are coated on water-soluble saccharide-containing particles under specific conditions, the resulting emulsifier product obtains advantageous properties.

An aspect of the invention pertains to a method of producing an emulsifier powder, preferably suitable for cold process gelato, the method comprising the steps of:
a) providing
   one or more emulsifier(s),
   water-soluble particles comprising a saccharide (wsp)
   optionally, one or more additional ingredient(s)
b) combining the one or more emulsifier(s), the wsp, and if used, the one or more additional ingredient(s), under conditions that keep the wsp in solid form, thereby obtaining a mixture, wherein the one or more emulsifier(s) contribute with 15-45% w/w of the mixture, and wherein the sum of the wsp and the one or more emulsifier(s) contributes with at least 80% w/w of the mixture, preferably at least 90% w/W,
optionally, c) cooling the mixture, preferably to a temperature that is at least 10 degrees C. lower than the melting temperature of the one or more emulsifier(s), more preferably at least 15 degrees C. lower than the melting temperature of the one or more emulsifier(s), and most preferably at least 20 degrees C. lower than the melting temperature of the one or more emulsifier(s),
optionally, d) reducing the particle size of and/or sifting the mixture,
optionally, e) packaging the obtained emulsifier powder, preferably the product resulting from step b), c) or d).

Another aspect of the invention pertains to an emulsifier powder suitable for cold process gelato, the emulsifier powder comprising:
one or more emulsifier(s),
water-soluble particles comprising a saccharide
optionally, one or more additional ingredient(s)
   wherein the one or more emulsifier(s) contribute with 15-45% w/w of the emulsifier powder, and
   wherein the sum of the wsp and the one or more emulsifier(s) contributes with at least 80% w/w of the emulsifier powder, preferably at least 90% w/w.

Yet an aspect of the invention pertains to use of the emulsifier powder of the invention as an ingredient in the production of a food product produced using temperatures of at most 60 degrees C., more preferably at most 40 degrees C., even more preferred at most 20 degrees C. and most preferably at most 10 degrees C.

A further aspect of the invention pertains to a process of producing a food product, preferably without using temperatures higher than 60 degrees C., the process comprising the steps of:
i) mixing the emulsifier powder according to the invention with one or more ingredients to provide a first food composition, and
optionally, ii) processing the first food composition of step i).

Yet another aspect of the invention pertains to a food product obtainable by the process of the invention, preferably in the form of a gelato.

### SUMMARY OF THE FIGURE

FIG. 1 shows the water absorption in different emulsifier powders as function of relative humidity during storage in an open container at 25 degrees C.

### DETAILED DESCRIPTION

An aspect of the invention pertains to a method of producing an emulsifier powder, preferably suitable for cold process gelato production, the method comprising
a) providing
   one or more emulsifier(s),
   water-soluble particles comprising a saccharide (wsp)
   optionally, one or more additional ingredient(s), e.g. a stabilizer, an antioxidant, a fat, and/or a protein,
b) combining the one or more emulsifier(s), the wsp, and if used, the one or more additional ingredient(s), under conditions that keep the wsp in solid form, thereby obtaining a mixture, wherein the one or more emulsifier(s) contribute with 15-45% w/w of the mixture, and wherein the sum of the wsp and the one or more emulsifier(s) contributes with at least 80% w/w of the mixture, preferably at least 90% w/w,
optionally, c) cooling the mixture, preferably to a temperature that is at least 10 degrees C. lower than the melting temperature of the one or more emulsifier(s), more preferably at least 15 degrees C. lower than the melting temperature of the one or more emulsifier(s), and most preferably at least 20 degrees C. lower than the melting temperature of the one or more emulsifier(s),
optionally, d) reducing the particle size of and/or sifting the mixture,
optionally, e) packaging the obtained emulsifier powder.

In some preferred embodiments of the present invention the emulsifier powder is the product obtained from step b).

In other preferred embodiments of the present invention the emulsifier powder is the product obtained from step c).

In further preferred embodiments of the present invention the emulsifier powder is the product obtained from step d).

In the context of the present invention the term “emulsifier powder” pertains to the product of the present invention and comprises one or more emulsifier(s) and water-soluble particles. The water-soluble particles preferably act as carriers for the one or more emulsifier(s). The water-soluble particles may be fully or partially coated by the one or more emulsifier(s).

In the context of the present invention the term “one or more emulsifier(s)” pertains to the emulsifier or emulsifiers used in the emulsifier powder of the invention. The one or more emulsifier(s) are preferably food-grade emulsifier(s). Emulsifiers useful for food production are well-known to the skilled person. The term “one or more emulsifier(s)” covers both embodiments that employ a single emulsifier and that employ several emulsifiers even though the verb used in relation to the term is presented in singular or plural form.

In the context of the present invention the term “water-soluble particles” pertains to particles that are soluble in water. The water-soluble particles may form a free flowing powder. Preferably, water-soluble particles comprise any food-grade water-soluble particles.

The water-soluble particles in the invention comprise a saccharide. The abbreviation “wsp” relates to water-soluble particles comprising a saccharide. Preferably, the wsp form a free flowing powder. It is furthermore preferred that the wsp are food-grade.

In the context of the present invention a composition that is “water-soluble” or “soluble in water” has a solubility in water of at least 5 g/100 g water at 25 degrees C.

In the context of the present invention the term “free flowing” pertains to a property of a powder. A powder is free flowing, when its particles do not form aggregates or stick together during handling.

In the context of the present invention the term “cold-water soluble/dispersible” pertains to an emulsifier powder which is easily dispersed and functional when blended in water or aqueous liquids at 5 degrees C.

In the context of the present invention the term “the melting temperature of the one or more emulsifier(s)” pertains to the temperature wherein the one or more emulsifier(s) obtain the appearance of a clear liquid.

The one or more emulsifier(s) are preferably selected from edible emulsifier(s) and are preferably food-grade.

The one or more emulsifier(s) may be a single emulsifier or may alternatively comprise two or more emulsifiers. If more than one emulsifier are used they may be added individually during step b) or may be premixed prior to the addition in step b).

In some preferred embodiments of the present invention the one or more emulsifier(s) comprise a monoglyceride and/or a diglyceride. Preferably the one or more emulsifier(s) comprise at least a monoglyceride.

In other preferred embodiments of the present invention the one or more emulsifier(s) comprises a carboxylic acid ester of a monoglyceride and/or of a diglyceride, preferably lactic acid esters of mono- and diglycerides.

In further preferred embodiments of the present invention the one or more emulsifier(s) comprises one or more of monoglycerides, diglycerides, hydroxy carboxylic acid esters of monoglycerides, hydroxy carboxylic acid esters of diglycerides, lecithin, polyglycerol esters of fatty acids, polyglycerol esters of poly fatty acids, propylene glycol esters of fatty acids; hydroxy carboxylic acid ester of a fatty acid (preferably stearoyl lactylate), diacetyl tartaric acid ester of mono- and diglyceride, and mixtures thereof.

In some preferred embodiments of the present invention the one or more emulsifier(s) comprises hydroxy carboxylic acid ester of a fatty acid and preferably stearoyl lactylate.

In other preferred embodiments of the present invention the one or more emulsifier(s) comprises diacetyl tartaric acid ester of mono- and diglyceride.

In some preferred embodiments of the present invention the one or more emulsifier(s) comprises hydroxy carboxylic acid esters of diglycerides, preferably in the form of lactic acid esters of mono- and diglycerides

In other preferred embodiments of the present invention the one or more emulsifier(s) comprises polyglycerol esters of fatty acids and/or polyglycerol esters of poly fatty acids, preferably in the form of polyglycerol polyricinoleate.

In further preferred embodiments of the present invention the one or more emulsifier(s) comprises monoglyceride and lactic acid esters of mono- and diglycerides.

In some preferred embodiments of the present invention the one or more emulsifier(s) is provided as pellets or powder.

In some preferred embodiments of the present invention the one or more emulsifier(s) is provided as pellets or a powder and is provided in this form in step b).

In some preferred embodiments of the present invention the water content of the one or more emulsifier(s) is at most 5% w/w, more preferably at most 2% w/w, even more preferably at most 0.5% w/w, and most preferably at most 0.1% w/w.

The inventors have found that a low content of water in the one or more emulsifier(s) gives rise to a reduced development of stickiness during the production and the subsequent storage of the emulsifier powder.

In some preferred embodiments of the present invention the wsp are provided as a powder.

In some preferred embodiments of the present invention the wsp have a water-solubility of at least 20 g/100 g water at 25 degrees C., more preferably at least 30 g/100 g water at 25 degrees C., and most preferably at least 50 g/100 g water at 25 degrees C.

In some preferred embodiments of the present invention the wsp of step a) have a particle size distribution so that at least 80% w/w of the wsp have a particle size in the range of 10 micron to 1000 micron, more preferably at least 90% w/w of the wsp, and most preferred at least 95% w/w of the wsp.

In some preferred embodiments of the present invention the wsp of step a) have a particle size distribution so that at least 80% w/w of the wsp have a particle size in the range of 50 micron to 500 micron, more preferably at least 90% w/w of the wsp, and most preferred at least 95% w/w of the wsp.

In some preferred embodiments of the present invention the wsp comprise saccharide in an amount of at least 50% w/w relative to the total weight of the wsp, more preferably at least 70% w/w, even more preferred at least 80% w/w, and most preferred at least 90% w/w relative to the total weight of the wsp.

In other preferred embodiments of the present invention the wsp comprise saccharide in an amount of at least 93% w/w relative to the total weight of the wsp, more preferably at least 96% w/w, even more preferred at least 98% w/w, and most preferred at least 99% w/w relative to the total weight of the wsp.

In some preferred embodiments of the present invention the wsp comprise a single saccharide.

In other preferred embodiments of the present invention the wsp comprise at least two saccharides.

In other preferred embodiments of the present invention the saccharide of the wsp is selected from the group consisting of a polysaccharide, an oligosaccharide, a disaccharide, a monosaccharide, and mixtures thereof.

In further preferred embodiments of the present invention the saccharide of the wsp comprises, or even essentially consists of, polysaccharides.

In other preferred embodiments of the present invention the polysaccharides comprise maltodextrins.

In further preferred embodiments of the present invention the saccharide comprises dry glucose syrup.

In particularly preferred embodiments of the present invention the saccharide comprises maltodextrins and dry glucose syrup.

In some preferred embodiments of the present invention the saccharide of the wsp comprises, or even essentially consists of, disaccharide. Preferably, the disaccharide comprises lactose, maltose and/or sucrose.

In some preferred embodiments of the present invention the saccharide comprises, or even essentially consists of, monosaccharide. It is often preferred that the monosaccharide comprises fructose, galactose and/or glucose.

In some preferred embodiments of the present invention the water content of the wsp is at most 5% w/w, more preferably at most 2% w/w, even more preferably at most 0.5% w/w, and most preferably at most 0.1% w/w.

The inventors have found that a low content of water in the one or more emulsifier(s) gives rise to a reduced development of stickiness during the production and the subsequent storage of the emulsifier powder.

In some preferred embodiments of the present invention the one or more additional ingredient(s) provided in step a) comprise an antioxidant.

The antioxidant is preferably a food-grade antioxidant.

Useful examples of antioxidants comprise one or more of a tocopherol, a tocotrienol, a carotenoid, ascorbic acid, ascorbyl palmitate, tert-butylhydroquinone, benzoic acid and salts thereof.

In some preferred embodiments of the present invention the one or more additional ingredient(s) provided in step a) comprise a fat.

In the context of the present invention the term “fat” covers both high-triglyceride products that are solid at room temperature and high-triglyceride products that are liquid at room temperature.

The fat typically comprises a vegetable fat and/or an animal fat, e.g., milk fat.

The one or more additional ingredient(s) provided in step a) may e.g. comprise at least two fats, e.g. selected from vegetable fat and/or animal fat, e.g., milk fat.

In some preferred embodiments of the present invention the one or more additional ingredient(s) provided in step a) comprise a protein.

Preferred examples of the protein are vegetable protein and/or dairy proteins.

Useful examples of dairy proteins are, e.g., milk protein, casein, and/or whey protein.

It is often preferred that free water is not added during step b). The one or more additional ingredient(s) therefore preferably do not contain water as a separate ingredient.

In some preferred embodiments of the present invention the one or more emulsifier(s) contribute with 15-45% w/w of the mixture, more preferably 17-40% w/w, even more preferably 20-35% w/w, and most preferably 21-30% w/w of the mixture.

In other preferred embodiments of the present invention the one or more emulsifier(s) contribute with 20-45% w/w of the mixture, more preferably 21-45% w/w, even more preferably 25-45% w/w, and most preferably 30-45% w/w of the mixture.

In some preferred embodiments of the present invention the wsp contribute with 35-85% w/w of the mixture, more preferably 40-83% w/w, even more preferably 45-80% w/w, and most preferably 50-79% w/w of the mixture.

In further preferred embodiments of the present invention the water content of the mixture is at most 5% w/w, more preferably at most 2% w/w, even more preferably at most 0.5% w/w, and most preferably at most 0.1% w/w.

In some preferred embodiments of the present invention the protein content of the mixture is at most 5% w/w, more preferably at most 2% w/w, even more preferably at most 0.5% w/w, and most preferably at most 0.1% w/w.

In some preferred embodiments of the present invention the stabilizer content of the mixture is at most 5% w/w, more preferably at most 2% w/w, even more preferably at most 0.5% w/w, and most preferably at most 0.1% w/w.

In other preferred embodiments of the present invention the stabilizer comprises at least one stabilizer selected from the group consisting of alginate, carboxymethyl cellulose, microcrystalline cellulose, tara gum, agar, gelatine, gum acacia, pectin, guar gum, locust bean gum, gum tragacanth, xanthan, carrageenan, semi-refined carrageenan, eucheuma seaweed, semi-refined seaweed, semi-refined carrageenan, carob gum, starch, and mixtures thereof.

In some preferred embodiments of the present invention the temperature of the wsp during step b) is at least 10 degrees C. lower than the melting temperature of the one or more emulsifier(s), more preferably at least 15 degrees C. lower than the melting temperature of the one or more emulsifier(s), and most preferably at least 20 degrees C. lower than the melting temperature of the one or more emulsifier(s).

In other preferred embodiments of the present invention the temperature of the wsp during step b) is at most 60 degrees C., more preferably at most 55 degrees C., even more preferably at most 50 degrees C., and most preferably at most 45 degrees C.

In further preferred embodiments of the present invention the temperature of the wsp during step b) is in the range of −10 to 60 degrees C., more preferably 0 to 55 degrees C., even more preferably 2-50 degrees C., and most preferably in the range of 2-45 degrees C.

The inventors have found that controlling the temperature of the wsp during step b) is advantageous to avoid undesired aggregation of the wsp.

Step b) may involve active cooling of the wsp or intermediary mixture of wsp, emulsifier(s) and further ingredients to keep the temperature within the desired range.

In some preferred embodiments of the present invention step b) involves contacting the wsp in solid form with the one or more emulsifier(s) in solid form.

In other preferred embodiments of the present invention the one or more emulsifier(s) is added in step b) in the form of pellets or powder, preferably, followed by high shearing mixing using, e.g., a rotor-stator based shearing system or high shear blade system.

In further preferred embodiments of the present invention step b) involves contacting the wsp in solid form with the one or more emulsifier(s) in softened form.

In some preferred embodiments of the present invention step b) involves contacting the wsp in solid form with the one or more emulsifier(s) in melted form.

In further preferred embodiments of the present invention step b) involves adding the one or more emulsifier(s) in melted form to the wsp, preferably by spraying the one or more emulsifier(s). The inventors have found that application of the one or more emulsifier(s) by spraying onto the wsp provides an attractive product and reduces the risk of formation of large, solid emulsifier lumps in the emulsifier powder and gives rise to a better utilization of the emulsifier.

In some preferred embodiments of the present invention the temperature of the one or more emulsifier(s) when added in step b) is at least 2 degrees C. higher than the melting temperature of the one or more emulsifier(s), more preferably at least 4 degrees C. higher than the melting temperature of the one or more emulsifier(s), and most preferably at least 10 degrees C. higher than the melting temperature of the one or more emulsifier(s).

In other preferred embodiments of the present invention the temperature of the one or more emulsifier(s) when added in step b) is at least 65 degrees C., more preferably at least 70 degrees C., even more preferably at least 75 degrees C., and most preferably at least 80 degrees C.

In further preferred embodiments of the present invention the temperature of the one or more emulsifier(s) when added in step b) is in the range of 65 to 200 degrees C., more preferably 70 to 150 degrees C., even more preferably 75-100 degrees C., and most preferably in the range of 75-90 degrees C.

In other preferred embodiments of the present invention the temperature of the one or more emulsifier(s) when added in step b) is substantially the same as the temperature of the wsp.

It is often preferred that step b) involves mixing the wsp, and more preferably high shearing mixing, while and/or after the one or more emulsifier(s) are added. The inventors have found that adding the one or more emulsifier(s) while the wsp are subjected to mixing cause a more efficient application of the emulsifier(s) to the wsp.

Therefore, during step b), or at least a part of step b) the wsp are preferably present in a mixing device and subjected to mixing, more preferably high shearing mixing, while and/or after the one or more emulsifier(s) are added.

It is particularly preferred that step b) involves mixing the wsp, and more preferably high shearing mixing, while the one or more emulsifier(s) are added.

Preferably, the mixing, and more preferably high shearing mixing, is obtained by a rotor-stator-based shearing system, a high shear blade system, or similar equipment.

In some preferred embodiments of the present invention the method of producing an emulsifier powder comprises step c) when the mixture obtained from step b) has a temperature that is higher than desired.

In other preferred embodiments of the present invention the method comprises step c) of cooling the mixture.

Step c) is particularly relevant if the mixture obtained from step b) has a temperature that is higher than desired. The inventors have found that a cooling step may reduce the risk of sticking and lump-formation.

In further preferred embodiments of the present invention step c) may reduce the risk that the emulsifier powder is sticky and forms lumps.

In some preferred embodiments of the present invention the mixture is cooled to a temperature that is at least 10 degrees C. lower than the melting temperature of the one or more emulsifier(s), more preferably at least 15 degrees C. lower than the melting temperature of the one or more emulsifier(s), and most preferably at least 20 degrees C. lower than the melting temperature of the one or more emulsifier(s).

In other preferred embodiments of the present invention the mixture is cooled to a temperature in the range of −10 to 60 degrees C., more preferably 0 to 50 degrees C., even more preferably 2-40 degrees C., and most preferably in the range of 2-30 degrees C.

In some preferred embodiments of the present invention the method of producing an emulsifier powder comprises step d) involving particle size reduction, preferably operated to obtain a modified mixture wherein at least 80% w/w of the particles of the mixture have a particle size in the range of 100 micron-1000 micron.

In other preferred embodiments of the present invention the method of producing an emulsifier powder comprises step d) involving particle size reduction, preferably operated to obtain a modified mixture wherein
at least 10% w/w of the particles of the mixture have a particle size of at least 100 micron; and
at most 90% w/w of the particles of the mixture have a particle size of at most 1000 micron.

In other preferred embodiments of the present invention the method of producing an emulsifier powder comprises step d) involving particle size reduction, preferably operated to obtain a modified mixture wherein
at least 10% w/w of the particles of the mixture have a particle size of at least 120 micron; and
at most 90% w/w of the particles of the mixture have a particle size of at most 800 micron.

In some preferred embodiments of the present invention step d) involves one or more of sifting, analytical sieving, microfluidization, shearing, grinding, or milling.

In other preferred embodiments of the present invention step d) involves sifting the mixture, preferably after particle size reduction.

In some preferred embodiments of the present invention the method comprises step e) of packaging the obtained product of the method, e.g., the cooled mixture obtained from step c) or the processed mixture obtained from step d).

In other preferred embodiments of the present invention the product obtained from step c) or d) is packaged in a suitable container. Preferred examples of suitable containers comprise a bulk delivery truck, an intermediate bulk container, a drum, a can, a bag, or a box with a polymer liner.

An advantage of the present method relative to prior art methods is that it requires less energy per kg used emulsifier.

An aspect of the invention pertains to an emulsifier powder, preferably suitable for cold process gelato production, comprising:
one or more emulsifier(s),
water-soluble particles comprising a saccharide
optionally, one or more additional ingredient(s)
   wherein the one or more emulsifier(s) contribute with 15-45% w/w of the emulsifier powder, and
   wherein the sum of the wsp and the one or more emulsifier(s) contributes with at least 80% w/w of the emulsifier powder, preferably at least 90% w/w.

In some preferred embodiments of the present invention the emulsifier powder is obtainable by the method of producing an emulsifier powder, the method comprising
a) providing
   one or more emulsifier(s),
   water-soluble particles comprising a saccharide (wsp)
   optionally, one or more additional ingredient(s), e.g. a stabilizer, an antioxidant, a fat, and/or a protein,
b) combining the one or more emulsifier(s), the wsp, and if used, the one or more additional ingredient(s), under conditions that keep the wsp in solid form, thereby obtaining a mixture, wherein the one or more emulsifier(s) contribute with 15-45% w/w of the mixture, and wherein the sum of the wsp and the one or more emulsifier(s) contributes with at least 80% w/w of the mixture, preferably at least 90% w/w,
optionally, c) cooling the mixture, preferably to a temperature that is at least 10 degrees C. lower than the melting temperature of the one or more emulsifier(s), more preferably at least 15 degrees C. lower than the melting temperature of the one or more emulsifier(s), and most preferably at least 20 degrees C. lower than the melting temperature of the one or more emulsifier(s), optionally, d) reducing the particle size of and/or sifting the mixture, optionally, e) packaging the obtained emulsifier powder, preferably the product resulting from step b), c) or d).

In some preferred embodiments of the present invention the emulsifier powder has a particle size distribution, wherein more particles have a size of between 100 and 1000 micron than emulsifier powders prepared by spray-drying, by dispersing the one or more emulsifier(s) in a magma of a carrier material, or by spray-cooling a molten blend of the one or more emulsifier(s) and a carrier material.

In some preferred embodiments of the present invention the emulsifier powder has a particle size distribution so that at least 80% w/w of the emulsifier powder has a particle size in the range of 10 micron to 1000 micron, more preferably at least 90% w/w of the emulsifier powder, and most preferred at least 95% w/w of the emulsifier powder.

In other preferred embodiments of the present invention the emulsifier powder has a particle size distribution so that at least 80% w/w of the emulsifier powder has a particle size in the range of 50 micron to 500 micron, more preferably at least 90% w/w of the emulsifier powder, and most preferred at least 95% w/w of the emulsifier powder.

An advantage of the present invention is that the emulsifier powder has a reduced propensity to form dust.

In some preferred embodiments of the present invention the emulsifier powder has a bulk intensity of at least 0.4 g/cm³ and preferably at least 0.5 g/cm³.

In some preferred embodiments of the present invention the emulsifier powder may be distributed in water, wherein the carrier may dissolve and the emulsifier may be dispersed as particles, wherein at least 80% of the particles have a particle size of at most 20 micron, more preferably at most 90% of the particles have a particle size of at most 20 micron, and most preferably at most 98% of the particles have a particle size of at most 20 micron.

It is often preferred that the emulsifier powder provides a dispersion of emulsifier particles wherein at least 80% of the emulsifier particles have a particle size of at most 20 micron, more preferably at most 90% of the particles have a particle size of at most 20 micron, and most preferably at most 98% of the particles have a particle size of at most 20 micron, when 1 g of emulsifier powder is mixed in 99 g demineralised water having a temperature of 20 degrees C. and subjected to high shear for 30 seconds.

In some preferred embodiments of the present invention the emulsifier powder may be distributed in water, wherein the carrier may dissolve and the emulsifier may be dispersed as particles, wherein at least 90% of the particles have a particle size of at most 18 micron, more preferably at most 15 micron, and most preferably at most 12 micron.

It is often preferred that the emulsifier powder provides a dispersion of emulsifier particles wherein at least 90% of the emulsifier particles have a particle size of at most 18 micron, more preferably at most 15 micron, and most preferably at most 12 micron, when 1 g of emulsifier powder is mixed in 99 g demineralised water having a temperature of 20 degrees C. and subjected to high shear for 30 seconds.

In further preferred embodiments of the present invention the emulsifier powder provides a dispersion of emulsifier particles wherein at least 90% of the emulsifier particles have a particle size of at most 10 micron, more preferably at most 8 micron, and most preferably at most 6 micron, when 1 g of emulsifier powder is mixed in 99 g demineralised water having a temperature of 20 degrees C. and subjected to high shear for 30 seconds.

In further preferred embodiments of the present invention the emulsifier powder may be distributed in water, wherein the carrier may dissolve and the emulsifier may be dispersed as particles, wherein at least 90% of the particles have a particle size in the range of 5 micron-20 micron, more preferably in the range of 6 micron-15 micron, and most preferably in the range of 8 micron-12 micron.

It is often preferred that the emulsifier powder provides a dispersion of emulsifier particles wherein at least 90% of the particles have a particle size in the range of 5 micron-20 micron, more preferably in the range of 6 micron-15 micron, and most preferably in the range of 8 micron-12 micron.

The inventors have found the present emulsifier powder to have a lower water absorption than comparable prior art products. In some preferred embodiments of the present invention the emulsifier powder has a water absorption of at most 10% w/w at 70% relative humidity when measured according to Analysis 5, more preferably at most 9% w/w. The present emulsifier powder therefore seems to have a longer shelf-life.

Compositional features and preferences described in the context of the mixture equally apply to the emulsifier powder.

In some particularly preferred embodiments of the present invention, the emulsifier powder, which preferably is suitable for production of cold process gelato, comprises:
one or more emulsifier(s),
water-soluble particles comprising a saccharide
optionally, one or more additional ingredient(s)
   wherein the one or more emulsifier(s) contribute with 20-35% w/w of the emulsifier powder, and
   wherein the sum of the wsp and the one or more emulsifier(s) contributes with at least 90% w/w of the emulsifier powder,
   and furthermore wherein:
the protein content of the emulsifier powder is at most 5% w/w, more preferably at most 2% w/w, even more preferably at most 0.5% w/w, and most preferably at most 0.1% w/w.

In other particularly preferred embodiments of the present invention, the emulsifier powder, which preferably is suitable for production of cold process gelato, comprises:
one or more emulsifier(s),
water-soluble particles comprising a saccharide
optionally, one or more additional ingredient(s)
   wherein the one or more emulsifier(s) contribute with 20-35% w/w of the emulsifier powder, and
   wherein the sum of the wsp and the one or more emulsifier(s) contributes with at least 90% w/w of the emulsifier powder,
   and furthermore wherein:
the protein content of the emulsifier powder is at most 5% w/w, more preferably at most 2% w/w, even more preferably at most 0.5% w/w, and most preferably at most 0.1% w/w, and
the emulsifier powder has a particle size distribution so that at least 80% w/w of the emulsifier powder, and more preferably at least 90% w/w, has a particle size in the range of 50 micron to 500 micron.

In further particularly preferred embodiments of the present invention, the emulsifier powder, which preferably is suitable for production of cold process gelato, comprises:
one or more emulsifier(s),
water-soluble particles comprising a saccharide
optionally, one or more additional ingredient(s)
   wherein the one or more emulsifier(s) contribute with 20-35% w/w of the emulsifier powder, and
   wherein the sum of the wsp and the one or more emulsifier(s) contributes with at least 90% w/w of the emulsifier powder,
   and furthermore wherein:
the protein content of the emulsifier powder is at most 5% w/w, more preferably at most 2% w/w, even more preferably at most 0.5% w/w, and most preferably at most 0.1% w/w,
the emulsifier powder has a particle size distribution so that at least 80% w/w of the emulsifier powder, and more preferably at least 90% w/w, has a particle size in the range of 50 micron to 500 micron, and
when 1 g of the emulsifier powder is mixed in 99 g demineralised water having a temperature of 20 degrees C. and subjected to high shear for 30 seconds at least 80% of the emulsifier particles, and more preferably at least 90% of the emulsifier particles, have a particle size of at most 20 micron.

In even further particularly preferred embodiments of the present invention, the emulsifier powder, which preferably is suitable for production of cold process gelato, comprises:
one or more emulsifier(s),
water-soluble particles comprising a saccharide
optionally, one or more additional ingredient(s)
   wherein the one or more emulsifier(s) contribute with 20-35% w/w of the emulsifier powder, and
   wherein the sum of the wsp and the one or more emulsifier(s) contributes with at least 90% w/w of the emulsifier powder,
   and furthermore wherein:
the protein content of the emulsifier powder is at most 5% w/w, more preferably at most 2% w/w, even more preferably at most 0.5% w/w, and most preferably at most 0.1% w/w,
the emulsifier powder has a particle size distribution so that at least 80% w/w of the emulsifier powder, and more preferably at least 90% w/w, has a particle size in the range of 50 micron to 500 micron, and
when 1 g of the emulsifier powder is mixed in 99 g demineralised water having a temperature of 20 degrees C. and subjected to high shear for 30 seconds at least 80% of the emulsifier particles, and more preferably at least 90% of the emulsifier particles, have a particle size of at most 20 micron, and
the one or more emulsifier(s) comprises one or more of monoglycerides, diglycerides, hydroxy carboxylic acid esters of monoglycerides, hydroxy carboxylic acid esters of diglycerides, lecithin, polyglycerol esters of fatty acids, polyglycerol esters of poly fatty acids, propylene glycol esters of fatty acids; hydroxy carboxylic acid ester of a fatty acid (preferably stearoyl lactylate), diacetyl tartaric acid ester of mono- and diglyceride, and mixtures thereof.

In other particularly preferred embodiments of the present invention, the emulsifier powder, which preferably is suitable for production of cold process gelato, comprises:
one or more emulsifier(s),
water-soluble particles comprising a saccharide
optionally, one or more additional ingredient(s)
   wherein the one or more emulsifier(s) contribute with 20-35% w/w of the emulsifier powder, and
   wherein the sum of the wsp and the one or more emulsifier(s) contributes with at least 90% w/w of the emulsifier powder,
   and furthermore wherein:
the protein content of the emulsifier powder is at most 5% w/w, more preferably at most 2% w/w, even more preferably at most 0.5% w/w, and most preferably at most 0.1% w/W,
the emulsifier powder has a particle size distribution so that at least 80% w/w of the emulsifier powder, and more preferably at least 90% w/w, has a particle size in the range of 50 micron to 500 micron, and
the one or more emulsifier(s) comprises one or more of monoglycerides, diglycerides, hydroxy carboxylic acid esters of monoglycerides, hydroxy carboxylic acid esters of diglycerides, lecithin, polyglycerol esters of fatty acids, polyglycerol esters of poly fatty acids, propylene glycol esters of fatty acids; hydroxy carboxylic acid ester of a fatty acid (preferably stearoyl lactylate), diacetyl tartaric acid ester of mono- and diglyceride, and mixtures thereof.

Another aspect of the invention pertains to the use of the emulsifier powder of the invention as an ingredient in the production of a food product produced using temperatures of at most 60 degrees C., more preferably at most 40 degrees C., even more preferred at most 20 degrees C. and most preferably at most 10 degrees C.

In some preferred embodiments of the present invention the emulsifier powder of the invention contributes with at least 50% w/w of the total amount of emulsifier of the food product, more preferably at least 70% w/w, even more preferably at least 80% w/w, and most preferably at least 90% w/w of the total amount of emulsifier of the food product.

In some preferred embodiments of the present invention the emulsifier powder of the invention contributes with 0.05-4% w/w of weight of the food product, and most preferably 0.10-2% w/w of weight of the food product.

It is particularly preferred that the food product is a gelato type ice cream and preferably a cold process gelato.

An aspect of the invention pertains to a process of producing a food product, preferably without using temperatures higher than 60 degrees C., the process comprising the steps of:
i) mixing the emulsifier powder of the invention with one or more ingredients to provide a first food composition, and
optionally, ii) processing the first food composition of step i).

In some preferred embodiments of the present invention the process of producing a food product is performed without using temperatures higher than 60 degrees C., preferably without using temperatures higher than 40 degrees C., more preferably without using temperatures higher than 15 degrees C., even more preferably without using temperatures higher than 10 degrees C., and most preferably without using temperatures higher than 5 degrees C.

In some preferred embodiments of the present invention the process of producing a food product may be directed to producing a gelato.

Gelato is a well-known Italian frozen dessert that has a smooth, soft, silky texture and that is generally more flavorful than ice cream. A gelato composition includes an amount of total solids, including at least one milk-solids source, at least one sugar source, and at least one fat source, to provide a frozen gelato that can be stored for up to one year and still retain a texture characteristic of freshly-made gelato. Cold process gelato, i.e., prepared without pasteurizing the ice cream mix, is particularly preferred in relation to the present invention.

In some preferred embodiments of the present invention the process comprises step ii) of processing the first food composition of step i).

In other preferred embodiments of the present invention step ii) comprises allowing the food product to age, preferably at cold storage, more preferably at a temperature of at most 5 degrees C., most preferably at a temperature of at most 4 degrees C.

In some preferred embodiments of the present invention the process of producing a food product, preferably a gelato, is preferably performed without using temperatures higher than 15 degrees C., more preferably without using temperatures higher than 5 degrees C., wherein the process comprises the steps of
i) mixing, preferably blending, the emulsifier powder with one or more ingredients to provide a first food composition, wherein the one or more ingredients may comprise one or more of sucrose, glucose, skimmed milk powder, stabilizer(s), and dairy liquid, such as e.g. cream and/or milk;
ii) processing the first food composition of step i), wherein processing preferably comprises one or more of:
   allowing the first food composition of step i) to age, preferably wherein the first food composition has a temperature which is at most 10 degrees C. and for at least 10 minutes, more preferably at most 5 degrees C. for at least 15 minutes,
   freezing the first food composition either directly after step i) or after aging, preferably wherein the freezing temperature is in the range of −15 and −25 degrees C., more preferably in the range of −16 to −20 degrees C.

In some preferred embodiments of the present invention the emulsifier powder of the invention contributes with at least 50% w/w of the total amount of emulsifier of the food product, more preferably at least 70% w/w, even more preferably at least 80% w/w, and most preferably at least 90% w/w of the total amount of emulsifier of the food product.

In some preferred embodiments of the present invention the emulsifier powder of the invention contributes with 0.05-4% w/w of weight of the food product, and most preferably 0.2-2% w/w of weight of the food product.

It is particularly preferred that the food product is a gelato type ice cream and preferably a cold process gelato.

An aspect of the invention pertains to a food product obtainable by the process comprising the steps of:
i) mixing the emulsifier powder of the invention with one or more ingredients to provide a first food composition, and
optionally, ii) processing the first food composition of step i). It is particularly preferred that the food product is a gelato type ice cream and preferably a cold process gelato.

An advantage of the present emulsifier powder is that it does not give rise to graininess when used in cold-processed food products such as e.g. cold process gelato.

The present invention has been described above with reference to specific embodiments. However, other embodiments than the above described are equally possible within the scope of the invention. The different features and steps of various embodiments and aspects of the invention may be combined in other ways than those described herein unless it is stated otherwise.

### EXAMPLES

### Methods of Analysis

### Analysis 1: Determination of Energy Consumption

Energy consumption is calculated as kWh pr. ton of the product, i.e., emulsifier powder or emulsifier-only powder. The energy requirements are divided into two categories: energy related to the product itself (e.g., evaporation of water) and energy related to the production process (e.g., electrical motors, process heating/cooling). Energy related to the starting materials (e.g., production, transport, storage) as well as generic operations that would be approximately similar for all processes (e.g., melting of emulsifiers, post processing, heat loss/transfer, raw material handling) are considered.

The power usage related to the actual process is logged during production and converted to energy pr. produced unit by dividing the power with the throughput of the process.

$$\frac{E [ kWh ]}{m [ ton ]} = \frac{{P}_{l o g g e d} [ kW ]}{Thro ughput [ ton / h ]}$$

For one of the reference processes, spray drying, most of the energy usage stems from the evaporation of water. Therefore, the theoretical total energy pr. produced unit is calculated based on the assumption that the specific heat of vaporization, ΔHᵥₐₚ, of water stays constant at 2257 kJ/kg, regardless of solute concentration, and that the starting water content is 50% by mass.

$$\frac{E [ kWh ]}{m [ ton ]} = Δ {H}_{vap} [ kJ / kg ] \cdot 0.000278 [ kWh / kJ ] \cdot 1000 [ kg / ton ] + \frac{{P}_{l o g g e d} [ kW ]}{Thro ughput [ ton / h ]}$$

### Analysis 2: Determination of Loading

The term “loading” is used to describe the amount of emulsifier in the final product, denoted by a weight percent of total mass of the finished product (dry matter). Loading is calculated from mass balance during production and confirmed analytically by extraction with chloroform, according to AOAC Method 2003.06 (4.5.06) Final action 2006.

### Analysis 3: Determination of Particle Size Distribution

The volume weighted particle size distribution is measured by laser diffraction analysis (Horiba LA-9050) in correspondence with ISO 13320:2020. As all the measured particle types are opaque, the Fraunhofer theory was applied for all measurements.

Two different methods are used for the measurements, one for the dry powders and one for measuring the emulsifier particles after dispersion/solubilization of the powder product in water. Both methods are performed at room temperature. Settings and other relevant data are listed in Table 1.

TABLE 1
Instrument settings for particle analysis on Horiba LA-9050

| Method | Dry | Wet |
|---|---|---|
| Pre-dispersion | Sifting (mesh 5-10) | Ultra Turrax, medium speed, |
| | | 30 sec. |
| Dispersion media | Air (0.30 MPa) | Water (circulation speed 5, |
| | | agitation 5) |
| Ultrasound | N/A | Off |

| | |
|---|---|
| Transmittance | 95-98% |
| Distribution base | Volume |
| Sample refractive | Carbohydrate surface: 1.530-1.530i |
| index | Emulsifier surface: 1.460-0.000i |

### Analysis 4: Determination of Bulk Density

Bulk density is determined according to ASTM D1895 method A, by allowing the powder to flow freely into a suitable container with known mass and volume. Once full, the excess powder is scraped off with a straight edge, the container is weighed, and the bulk density determined as

$${ρ}_{b} [ g / {cm}^{3} ] = \frac{{m}_{total} - {m}_{container}}{{V}_{container}}$$

### Analysis 5: Gravimetric Determination of Water Absorption

A powder sample is spread thinly onto a sheet and kept for 7 days at 25 degrees C. and 20% relative humidity (RH) to ensure a low starting water content. A suitable amount of the powder sample is transferred under free flow conditions to a pre-weighed plastic petri dish. Any excess powder is scraped off with a straight edge to ensure the exposed surface of the powder being uniform in area. The powder sample is exposed to a stepwise increase in RH (40, 55 and 70% RH) while the temperature is held constant at 25 degrees C. The exposure time for each step is 72 hours. After each exposure interval, the powder sample is weighed, and the change in mass is recorded as a function of RH.

### Analysis 6: Determination of Viscosity

Dynamic viscosity of the gelato liquid mix is measured prior to freezing on a Brookfield DV3T viscometer using spindle-type LV-2, set at 20 rpm. The measurements are conducted at 4 degrees C., and the viscosity reading is taken after 30 seconds of rotation.

### Example 1: Production of a Cold-Water Soluble/Dispersible Emulsifier Powder

Example 1 illustrates the preparation of emulsifier powders by the method of the invention. Water-souble particles and emulsifier were chosen for use in a cold process gelato application. Five sets of process parameters within the method of the invention were tested with respect to powder characteristics of the obtained cold-water soluble/dispersible emulsifier powders.

### Preparation of Emulsifier Powders

As carrier, GLUCIDEX® 39 PREMIUM (solid glucose syrup-DE 39) was used as is, directly from the supplier, Roquette Freres. The emulsifier blend was prepared by individually melting the emulsifiers (Table 2) and then mixing the liquid emulsifiers in the required ratio (by weight). The molten emulsifier blend was then solidified by cooling to room temperature, either as pellets (approx. 5 mm in diameter) or as a fine powder (approximately 0.15 mm in diameter).

TABLE 2
Emulsifier blend for gelato mix

| | | Melting | | | | |
|---|---|---|---|---|---|---|
| | | point | | | Water | |
| | Amount | (degrees | Iodine value | Acid value | content | |
| Emulsifier | (wt. %) | C.) | (I₂/100 g) | (mg KOH/g) | (wt. %) | Purity |
| Distilled | 60 | 70 | <2 | <3 | ~0 | >90% |
| monoglyceride | | | | | | |
| (Palsgaard ® 0091) | | | | | | |
| Lactic Acid Esters of | 40 | 45-50 | <2 | <5 | ~0 | >95% |
| Mono and | | | | | | |
| Diglycerides | | | | | | |
| (Palsgaard ® 0420) | | | | | | |

Solid glucose syrup was added to a vertical twin shaft mixer with additional side-mounted horizontal blades/cutters. The mixer maintained a three-dimensional flow of the powder, while emulsifier blend was added to the solid glucose syrup. Different emulsifier addition methods were employed, including the addition method for powder 3, where the emulsifier was added to the vertical twin shaft mixer simultaneously with the solid glucose syrup. Further details regarding materials and process parameters of each emulsifier addition method can be found in Table 3, including the suitable loading values (determined previously; data not shown).

After the indicated mixing time, the temperature of the mixer was set to 20 degrees C. and mixing continued at a speed of 56 rpm, until the powder temperature reached 20═2 degrees C. (approximately 10-30 minutes). Powders 1, 2a, 2b and 3 were free flowing after the cooling step and did not require further processing/milling before being transferred to air-tight containers, whereas powder 2c was processed in a pulsed blade grinder to achieve a free flowing powder.

TABLE 3
Materials and processing parameters for production of water-soluble emulsifier powders by the
present method. Powder characteristics of the obtained water-soluble emulsifier powders.

| | | | | |
|---|---|---|---|---|
| Powder 1 | Powder 2a | Powder 2b | Powder 2c | Powder 3 |

Materials

| Solid glucose | 150 | kg | 150 | kg | 150 | kg | 150 | kg | 37.5 | kg |
|---|---|---|---|---|---|---|---|---|---|---|
| syrup - DE 39 | | | | | | | | | | |
| (GLUCIDEX ® | | | | | | | | | | |
| 39 | | | | | | | | | | |
| PREMIUM) | | | | | | | | | | |
| Emulsifier | 39.9 | kg | 50.0 | kg | 50.0 | kg | 50.0 | kg | 10 | kg |

blend

Process parameters

| Mixer | Amixon HM | | Amixon HM | | Amixon HM | | Amixon HM | | Aminxon EM | |
|---|---|---|---|---|---|---|---|---|---|---|
| | 400 | | 400 | | 400 | | 400 | | 100 | |
| Loading | 21.0% | | 25.0% | | 25.0% | | 25.0% | | 21.1% | |
| Process | 30-50 | | 25-40 | | 5-25 degrees | | 40-60 | | 20-40 | |
| temperature | degrees C. | | degrees C. | | C. | | degrees C. | | degrees C. | |
| limit | | | | | | | | | | |
| Mixing speed | 56 | rpm | 105 | rpm | 105 | rpm | 105 | rpm | 60 | rpm |
| Mixing time | 20 | min. | 37 | min. | 37 | min. | 37 | min. | 25 | min. |
| Emulsifier | Melted (80 | | Melted (80 | | Melted (80 | | Melted (80 | | Solid, fine | |
| addition | degrees C.) | | degrees C.) | | degrees C.) | | degrees C.) | | powder, | |
| | Standard | | Atomizing | | Atomizing | | Atomizing | | added from | |
| | nozzle, | | nozzle, | | nozzle, | | nozzle, | | start | |
| | 4 kg/min | | 2 kg/min | | 2 kg/min | | 2 kg/min | | | |
| | | | Air press.: 1.8 | | Air press.: 1.8 | | Air press.: 1.8 | | | |
| | | | bar | | bar | | ba | | | |
| | | | Air temp.: | | Air temp.: | | Air temp.: | | | |
| | | | 120 degrees | | 120 degrees | | 120 degrees | | | |
| | | | C. | | C. | | C. | | | |
| Side blade | High shear | | S-type cutters | | S-type cutters | | S-type cutters | | Rotor-stator | |
| type | blades | | | | | | | | | |
| Side blade | 2100 | rpm | 1800 | rpm | 1800 | rpm | 1800 | rpm | 2100 | rpm |

speed

Powder characteristics

| | | | | | |
|---|---|---|---|---|---|
| Coating | High | Excellent | Medium | Excellent | Medium |
| efficiency | | | | | |
| Free flowing | Yes | Yes | Yes | Partially | Yes |
| Dispersibility | Medium | Excellent | Medium | good | Medium |
| Stickiness | Slightly | None | None | Slightly | None |
| Appearance | Granular, | Powder | Powder + | Granular, | Powder |
| | aggregation | | medium | aggregation | |
| | dominated by | | fragments of | dominated by | |
| | emulsifier | | aggregated | carrier | |
| | | | emulsifier | | |

### Powder Characteristics

The following powder characteristics were determined for the obtained emulsifier powders. The results are displayed in Table 3.

The coating efficiency was determined visually by evaluating the amount of emulsifier in the finished product not coated onto the carrier. The coating efficiency was regarded as excellent (substantially no particles of free emulsifier were present), high (only few particles of free emulsifier were present), and medium (a significant number of free emulsifier particles were present). An excellent or high coating efficiency is regarded as acceptable for an emulsifier powder suitable for gelato production.

Powder flowability was determined to be free-flowing, when it would flow easily under its own gravitational force, without the need for shaking or tapping the container.

Dispersibility was determined by adding 1 gram of the powder into 20 mL tap water at room temperature and shaking vigorously by hand for 30 seconds. The dispersibility was regarded as excellent, good, and medium, respectively, when none, some or a significant amount of solid particles were left after shaking. An excellent, good, and medium dispersibility is regarded as acceptable for an emulsifier powder suitable for gelato production.

Stickiness was determined by a powder's tendency to form clumps and/or cakes. A powder was regarded as slightly sticky, when loose clumps and/or cakes did form over time, but were easily broken if moved. For an emulsifier powder suitable for gelato production, it is acceptable to be slightly sticky but it is more preferred that it is not.

As a further powder characteristic, it was described whether the emulsification powder appeared like a powder, a powder with medium fragments or appeared to have a granular structure. Medium fragments are defined as aggregates no more than 2 mm in diameter, interspersed in a free flowing powder with general particle sizes between 100-1000 micron.

For some applications, it is advantageous if an emulsifier powder appears like a powder. For other applications, it is advantageous if an emulsifier powder appears granular.

### CONCLUSION

The present method successfully allowed for the production of emulsifier powders within a range of process parameters such as loading, mixing speed and process temperature limits. By adjusting these process parameters, powder characteristics can be tailored to be advantageous for the given application of the emulsifier powders.

The process parameters for production of powders 2a, 2b, and 2c differed only in the process temperature limits. By comparing powder 2a with powder 2b and 2c, it is clear that a strict temperature control is advantageous, as too low a temperature gives inefficient coating, while too high a temperature causes the carrier to become sticky.

Among the produced emulsifier powders, powder 2a was found to possess the powder characteristics and loading capability best suited for the cold process gelato application. Powder 2a was therefore chosen as the primary candidate for reference comparison and application trial.

### Example 2: Production of Reference Emulsifier Systems (Prior Art)

Three reference emulsifier powders were produced using the same carrier material and emulsifier as in Example 1, but employing methods known from the prior art.

Powder Ref. A: Spray Dried

The spray drying method is often considered the classical/conventional method of producing a cold-water soluble/dispersible emulsifier product for foodstuff. It is produced by mixing the emulsifier and the carrier in water and then spraying the mixture into a stream of hot gas (typically air or nitrogen). As the water evaporates from the droplets, the carrier and emulsifier co-precipitate as a fine powder.

The materials and process parameter used for the production of powder ref. A are presented in Table 4 (pre-spray emulsion) and Table 5 (spray dryer).

TABLE 4
Pre-spray emulsion materials and processing
parameters for powder ref. A
Materials

| | | |
|---|---|---|
| Solid glucose syrup (GLUCIDEX ® | 40 | kg |
| 39 PREMIUM) | | |
| Lactose monohydrate (Variolac | 30 | kg |
| 992BG) | | |
| Emulsifier blend (Table 2) | 30 | kg |
| Deionized water | 100 | kg |

Process parameters

| Mixing unit | High speed mixer (gear pump) | |
|---|---|---|
| Mixing temperature | 60 | degrees C. |
| Mixing time | 5 | min |
| Homogenizer | 1 | stage |
| Homogenization temperature | 60 | degrees C. |
| Homogenization pressure | 175 | bar |

TABLE 5
Materials and processing parameters
for spray drying of powder ref. A
Materials

| | |
|---|---|
| Emulsion from Table 4 | Kept in holding tank |
| | at 50 degrees C. |

Process parameters

| Equipment | Anhydro MS 400-3 2-stage setup | |
|---|---|---|
| Nozzle | Swirl-air 707-SL-29 | |
| Atomization method | 2-chamber cocurrent flow | |
| Product pump | 40% | |
| Product pressure | 1.5 | bar |
| Nozzle air pressure | 2 | bar |
| Nozzle air temperature | 50 | degrees C. |
| Drying air, in | 190 | degrees C. |
| Drying air out | 85 | degrees C. |
| Fluid bed air | 35 | degrees C. |
| Cyclone, differential pressure | 80 | mm H₂O |
| Product temperature | 51 | degrees C. |

Powder Ref. B: Magma Method (Extruded)

The magma method is described in patent U.S. Pat. No. 6,004,594, wherein the carrier is melted during extrusion and the emulsifiers dispersed in the molten matrix. Upon cooling, the solidified matrix can be milled to the required size. For the production of powder ref. B, the process parameters of U.S. Pat. No. 6,004,594 (Example 1) were followed closely to ensure the validity of the reference powder (albeit with slightly increased loading, see Example 4.1). Please refer to U.S. Pat. No. 6,004,594 for a complete process description.

Powder Ref. C: Spray-Cooled (No Carrier)

The spray-cooling method can, for some types of emulsifiers, produce an emulsifier powder with small, solid particles of emulsifier (no carrier). This type of powder is not water-soluble, but if particle sizes are small enough, it can be dispersed in water by high-shear stirring.

Materials and process parameter used for the production of powder ref. C are presented in Table 6.

TABLE 6
Materials and processing parameters
for spray-cooling of powder ref. C
Materials

| | |
|---|---|
| Emulsifier blend (Table 2) | Kept in holding tank |
| | at 69 degrees C. |

Process parameters

| Equipment | Anhydro MS 400-3 2-stage setup | |
|---|---|---|
| Nozzle | Swirl-air 707-SL-29 | |
| Atomization method | 2-chamber cocurrent flow | |
| Product pump | 30% | |
| Product pressure | 1.5 | bar |
| Nozzle air pressure | 6 | bar |
| Nozzle air temperature | 70 | degrees C. |
| Cooling air, in | −5 | degrees C. |
| Cooling air out | 10 | degrees C. |
| Fluid bed air | 1 | degrees C. |
| Cyclone, differential pressure | 95 | mmH₂O |
| Product temperature | 8 | degrees C. |

### Example 3: Comparison of Energy Consumption for Production of Emulsifier Powder

The energy consumption to produce emulsifier powders via spray drying (powder ref. A), extrusion (magma method, powder ref. B) and the present process (powder 2a) was compared.

The energy consumption is based on measurements, calculations, and estimates and presented in Table 7, both as kWh per metric ton of powder and as kWh per metric ton of active emulsifier contained in the powder.

TABLE 7
Energy consumption for various production methods

| | Emulsifier | | (kWh/ton active |
|---|---|---|---|
| | content (wt. %) | (kWh/ton) | emulsifier) |
| Powder ref. A | 30 | 752 | 2508 |
| Powder ref. B | 15 | 109 | 727 |
| Powder 2a | 25 | 95 | 308 |

### Conclusion

It is evident that the present process is substantially more energy efficient during production than other comparable methods, especially when the high loading is taken into account, if compared with the extruded magma-style product.

This it not only beneficial for economic reasons but also holds the potential to significantly cut back on the environmental footprint for these types of products.

### Example 4: Physical Characterization of the Product of the Invention and Comparison with Prior Art Products

Example 4 illustrates how an emulsifier powder produced by the flow-assisted process of the invention performs compared to reference emulsifier powders produced by methods known from prior art. Specifically, the emulsifier powders were compared based on physical properties that may affect their performances in cold process gelato application: loading, particle size distribution, bulk density, and water absorption.

### Example 4.1: Loading

Loading was determined as described in section “Analysis 2”.

Loadings for spray dried products containing active emulsifiers vary, but are typically found to be between 20-30%. For the reference used here (powder ref. A), a loading of 30% was chosen. The loading was calculated by mass balance and confirmed analytically.

Recreation of the magma method (powder ref. B) revealed a minor discrepancy between the loading calculated from mass balance and the loading measured analytically. It was therefore attempted to increase loading slightly during extrusion. During this, an absolute maximum loading of 15% was found for this system (measured analytically), corresponding to a mass balance loading of 16%. Any attempts to increase the loading further resulted in an irreversible separation of the emulsifiers and the carrier material with the consequence that the extruder had to be shut down and cleaned.

Mass balance calculated loading for the present process has already been presented in Table 3. For all produced powders the calculated loadings were confirmed analytically.

For spray-cooled powders (powder ref. C), the term “loading” was not applicable, as the powder did not contain any carrier. For calculation purposes, loading was defined as being of 100%.

### Example 4.2: Particle Size Distribution

Particle size distribution was determined as described in section “Analysis 3”.

### Example 4.2.1: Finished Powder Products

Particle size distribution of powder 2a and powder ref. A, B, and C was measured in their dry state. The emphasis on particle size distribution for these powders was two-fold.

Table 8 presents data from particle size measurements, represented as the median size as well as the D10 and the D90 sizes, i.e., the limits where 10 and 90% of the particles were below the reported size.

TABLE 8
Particle sizes of dry powders

| Product | Median (micron) | D10 (micron) | D90 (micron) |
|---|---|---|---|
| Powder 2a | 309.2 | 131.9 | 711.9 |
| Powder ref. A | 134.1 | 48.7 | 268.5 |
| Powder ref. B | 225.9 | 83.0 | 471.1 |
| Powder ref. C | 129.3 | 35.0 | 698.0 |

### Example 4.2.2: Emulsifier Particles Distributed in Water

Table 9 presents data from particle size measurements of dispersed emulsifier particles performed as described in section “Analysis 3”. From this it is evident that all measurements were well below the 20 micron threshold, except for powder ref. C, where the measurement failed due to low shear mixing during analysis, leading to particle aggregation. In high shear environments, particles can be assumed to be approximately similar in sizes as for the dry state.

TABLE 9
Particle sizes of dispersed emulsifiers

| Product | Median (micron) | D10 (micron) | D90 (micron) |
|---|---|---|---|
| Powder 2a | 9.44 | 8.32 | 11.25 |
| Powder ref. A | 2.95 | 1.79 | 4.07 |
| Powder ref. B | 3.23 | 2.03 | 4.35 |

| | |
|---|---|
| Powder ref. C | N/A |

### Example 4.3: Bulk Density

Bulk density of powder 2a and powder ref. A, B, and C was measured. Table 10 presents the results of the apparent bulk density.

TABLE 10
Bulk density of dry powders

| | Apparent bulk |
|---|---|
| | density |
| Product | (g/cm³) |
| Powder 2a | 0.56 |
| Powder ref. A | 0.38 |
| Powder ref. B | 0.34 |
| Powder ref. C | 0.25 |

### Example 4.4: Water Absorption

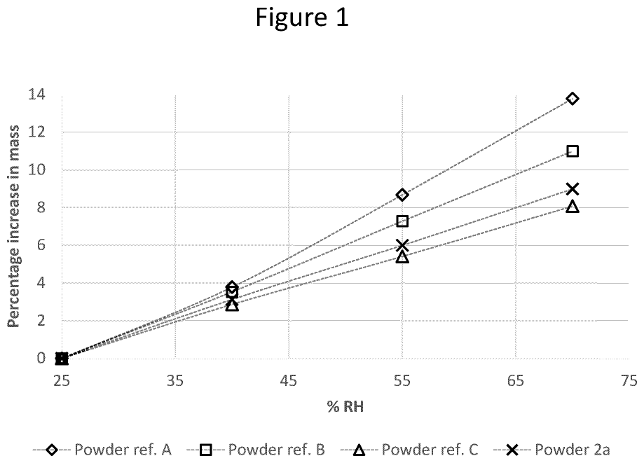

Water absorption of powder 2a and powder ref. A, B, and C was measured as described in section “Analysis 5.” The results are presented in FIG. 1. Both powder ref. A and B showed a higher tendency to absorb moisture from the surrounding air, which correspondingly resulted in a severe caking effect, forming a sticky crust on top of the samples. In contrast, powder 2a and powder ref. C had a significantly lower moisture absorption and showed no signs of caking.

### Conclusion

The inventors have found that the method of the invention produced cold-water soluble emulsifier powder products (e.g. powder 2a), that performed either better than or on par with comparable prior art products (powder ref. A, B, and C) for all the measured characteristics.

### Loading and Bulk Density

The method of the invention resulted in an emulsifier product with a higher loading than the product made using the magma method. In addition, the emulsifier product of the invention had surprisingly by far the highest bulk density compared to the products made by the prior art methods. The high loading combined with the highest apparent bulk density translates to a lower demand on warehouse space and transportation, which further contributes to the positive impact of the low energy requirements (Example 3) for the present method.

### Particle Size Distribution—Dry Powders

For emulsifier powders, it is advantageous that the particle sizes are distributed so that most powder particles fall within a desired range: Firstly, very small particles (below 100 micron) are generally unwanted, as they may create issues with dust. Secondly, very large particles (above 1000 micron) are also not preferred, as they reduce the total volume weighted surface area, and thus might take longer to dissolve/disperse. In that sense, it is advantageous to balance between limiting dust issues and the time needed for the particles to dissolve/disperse. With at least 80% of the particles falling with the desired range of 100-1000 micron, the emulsifier powder of the invention surprisingly surpassed the products made by the prior art methods. The emulsifier of the invention was particularly superior in avoiding the above-mentioned dust issues, as it was the only powder with a D10 above 100 micron.

### Particle Size Distribution—Dispersed Emulsifiers

It is generally acknowledged that particles above 20 micron in foods tend to bring about a grainy/mealy mouthfeel and should thus be avoided. For particle sizes of below 20 micron, size differences are non-detectable, as the upper sensory limit is 20 micron. After dissolution of the carrier and dispersion of the emulsifier particles, the emulsifier powder of the invention contained particles of below 20 micron and was thus on par with the prior art method of spray drying and the magma method. This analysis also highlighted the main disadvantage of using a pure emulsifier (powder ref. C), as the hydrophobic nature of the emulsifiers caused the particles to immediately aggregate in water in absence of vigorous stirring.

### Water Absorption

The inventors have found that the emulsifier powder of the invention is significantly less sensitive to humid conditions than the products of the spray drying method and the magma method. This was based on the prevalence of either a hydrophilic carbohydrate dominated surface (powder ref. A and B) or a hydrophobic emulsifier dominated surface (powder 2a and powder ref. c). Lower water absorption, such as displayed by the emulsifier powder of the invention, is advantageous relative to the higher water absorption of the emulsifier powders of the prior art methods, as a high water absorption leads to a significantly shortened shelf-life in humid climates, if the powder is not properly sealed. A low water absorption is therefore generally advantageous.

### SUMMARY

For each individual measured characteristic, the emulsifier powder made by the method of the invention performs on par with or surprisingly better than the products made by the methods of the prior art.

Taken together, the novel emulsifier powder and the method of the invention are superior relative to the prior art.

### Example 5: Application of the Invented Product

The functionality of powder 2a and powder ref. A-C was compared in a cold process gelato application.

A standard cold process gelato recipe was used for all trials with the ingredients used in each trial presented in Table 11.

TABLE 11
Ingredients for the gelato recipe.

| | | | |
|---|---|---|---|
| Gelato | Gelato | Gelato | Gelato |
| sample 1 | sample 2 | sample 3 | sample 4 |

Ingredients (wt. %)

| | | | | |
|---|---|---|---|---|
| Sucrose | 13.70 | 13.70 | 13.70 | 13.70 |
| Solid glucose | 2.40 | 2.60 | 1.60 | 3.30 |
| syrup | | | | |
| (GLUCIDEX ® | | | | |
| 39 PREMIUM) | | | | |
| Glucose | 1.45 | 1.45 | 1.45 | 1.45 |
| Skimmed milk | 3.30 | 3.30 | 3.30 | 3.30 |
| powder | | | | |
| Cream, 38% fat | 10.50 | 10.50 | 10.50 | 10.50 |
| Whole milk, | 67.25 | 67.25 | 67.25 | 67.25 |
| 3.5% fat | | | | |
| Stabilizers | 0.20 | 0.20 | 0.20 | 0.20 |
| (Palsgaard ® | | | | |
| WaterIce 815) | | | | |
| Powder 2a | 1.20 | | | |
| Powder ref. A | | 1.00 | | |
| Powder ref. B | | | 2.00 | |
| Powder ref. C | | | | 0.30 |

Process parameters

| Mixing | IKA Ultra Turrax, medium speed, | | | |
|---|---|---|---|---|
| | 60 seconds, approx. 5 degrees C. | | | |
| Aging | 4 degrees C., 15 minutes | | | |
| Viscosity | 148 | 153 | 136 | 141 |
| | mPa · s | mPa · s | mPa · s | mPa · s |

The ingredients were mixed with an IKA Ultra Turrax® at medium speed for 60 seconds at approximately 5 degrees C. The gelato mixes were then allowed to age for 15 minutes in cold storage at 4 degrees C. Subsequently the viscosities of the gelato mixes were measured according to Analysis 6, and the gelato mixes were frozen. The gelato samples were subjected to sensory evaluation within 2 days of freezing.

All four trials showed values of viscosity within the desired range (130 to 160 mPa·s). Similarly, gelato from all trials were evaluated to have a chewy, rich, and creamy mouthfeel, with a clean melt and a good distribution within the mouth during melting. The trial using spray-cooled emulsifiers did however present with a slightly grainy/mealy mouthfeel and some larger particles could also be detected. This was not the case for neither of the other three trials, which all were perceived as smooth.

### Conclusion

The inventors have found that the new emulsifier powder provided seamless replacement for known emulsifier powders in gelato production.

1. A method of producing an emulsifier powder suitable for cold process gelato, the method comprising the steps of:
a) providing
one or more emulsifier(s),
water-soluble particles comprising a saccharide (wsp)
optionally, one or more additional ingredient(s)
wherein the wsp have a water-solubility of at least 20 g/100 g water at 25 degrees C.,
b) combining the one or more emulsifier(s), the wsp, and if used, the one or more additional ingredient(s), under conditions that keep the wsp in solid form, thereby obtaining a mixture,
wherein the one or more emulsifier(s) contribute with 15-45% w/w of the mixture, and
wherein the sum of the wsp and the one or more emulsifier(s) contributes with at least 80% w/w of the mixture, preferably at least 90% w/w,
optionally, c) cooling the mixture, preferably to a temperature that is at least 10 degrees C. lower than the melting temperature of the one or more emulsifier(s), more preferably at least 15 degrees C. lower than the melting temperature of the one or more emulsifier(s), and most preferably at least 20 degrees C. lower than the melting temperature of the one or more emulsifier(s),
optionally, d) reducing the particle size of and/or sifting the mixture,
optionally, e) packaging the obtained emulsifier powder, preferably the product resulting from step b), c) or d).

2. The method according to claim 1, wherein the one or more emulsifier(s) comprises a monoglyceride and/or a diglyceride, preferably monoglyceride.

3. The method according to claim 1 or 2, wherein the one or more emulsifier(s) comprise a carboxylic acid ester of a monoglyceride and/or of a diglyceride, preferably lactic acid esters of mono- and diglycerides.

4. The method according to any one of the preceding claims, wherein the one or more emulsifier(s) comprise one or more of monoglycerides, diglycerides, hydroxy carboxylic acid esters of monoglycerides, hydroxy carboxylic acid esters of diglycerides, lecithin, polyglycerol esters of fatty acids, polyglycerol esters of poly fatty acids, propylene glycol esters of fatty acids, hydroxy carboxylic acid ester of a fatty acid (preferably stearoyl lactylate), diacetyl tartaric acid ester of mono- and diglyceride, and mixtures thereof.

5. The method according to any one of the preceding claims, wherein the one or more emulsifier(s) comprise monoglyceride and lactic acid esters of mono- and diglycerides.

6. The method according to any one of the preceding claims, wherein the one or more emulsifier(s) are provided as pellets or powder.

7. The method according to any one of the preceding claims, wherein the water content of the one or more emulsifier(s) is at most 5% w/w, more preferably at most 2% w/w, even more preferably at most 0.5% w/w, and most preferably at most 0.1% w/w.

8. The method according to any one of the preceding claims, wherein the wsp are provided as a powder.

9. The method according to any one of the preceding claims, wherein the wsp have a water-solubility of at least 30 g/100 g water at 25 degrees C., and most preferably at least 50 g/100 g water at 25 degrees C.

10. The method according to any one of the preceding claims, wherein the wsp comprise saccharide in an amount of at least 50% w/w relative to the total weight of the wsp, more preferably at least 70% w/w, even more preferred at least 80% w/w, and most preferred at least 90% w/w relative to the total weight of the wsp.

11. The method according to any one of the preceding claims, wherein the wsp comprise saccharide in an amount of at least 93% w/w relative to the total weight of the wsp, more preferably at least 96% w/w, even more preferred at least 98% w/w, and most preferred at least 99% w/w relative to the total weight of the wsp.

12. The method according to any one of the preceding claims, wherein the wsp comprise at least two saccharides.

13. The method according to any one of the preceding claims, wherein the saccharide of the wsp is selected from the group consisting a polysaccharide, an oligosaccharide, a disaccharide, a monosaccharide, and mixtures thereof.

14. The method according to any one of the preceding claims, wherein the saccharide of the wsp comprises, or even essentially consists of, polysaccharides.

15. The method according to claim 14, wherein the polysaccharides comprise maltodextrins or dry glucose syrup.

16. The method according to any one of the preceding claims, wherein the saccharide the wsp comprises, or even essentially consists of, disaccharide.

17. The method according to any one of claims 13-16, wherein the disaccharide comprises lactose, maltose and/or sucrose.

18. The method according to any one of the preceding claims, wherein the saccharide comprises, or even essentially consists of, monosaccharide.

19. The method according to any one of claims 13-18, wherein the monosaccharide comprises fructose, galactose and/or glucose.

20. The method according to any one of the preceding claims, wherein the water content of the wsp is at most 5% w/w, more preferably at most 2% w/w, even more preferably at most 0.5% w/w, and most preferably at most 0.1% w/w.

21. The method according to any one of the preceding claims, wherein the one or more emulsifier(s) contribute with 15-45% w/w of the mixture, more preferably 17-40% w/w, even more preferably 20-35% w/w, and most preferably 21-30% w/w of the mixture.

22. The method according to any one of the preceding claims, wherein the wsp contribute with 35-85% w/w of the mixture, more preferably 40-83% w/w, even more preferably 45-80% w/w, and most preferably 50-79% w/w of the mixture.

23. The method according to any one of the preceding claims, wherein the water content of the mixture is at most 5% w/w, more preferably at most 2% w/w, even more preferably at most 0.5% w/w, and most preferably at most 0.1% w/w.

24. The method according to any one of the preceding claims, wherein the protein content of the mixture is at most 5% w/w, more preferably at most 2% w/w, even more preferably at most 0.5% w/w, and most preferably at most 0.1% w/w.

25. The method according to any one of the preceding claims, wherein the stabilizer content of the mixture is at most 5% w/w, more preferably at most 2% w/w, even more preferably at most 0.5% w/w, and most preferably at most 0.1% w/w.

26. The method according to any one of the preceding claims, wherein the stabilizer comprises at least one stabilizer selected from the group consisting of alginate, carboxymethyl cellulose, microcrystalline cellulose, tara gum, agar, gelatine, gum acacia, pectin, guar gum, locust bean gum, gum tragacanth, xanthan, carrageenan, semi-refined carrageenan, eucheuma seaweed, semi-refined seaweed, semi-refined carrageenan, carob gum, and mixtures thereof.

27. The method according to any one of the preceding claims, wherein the temperature of the wsp during step b) is at least 10 degrees C. lower than the melting temperature of the one or more emulsifier(s), more preferably at least 15 degrees C. lower than the melting temperature of the one or more emulsifier(s), and most preferably at least 20 degrees C. lower than the melting temperature of the one or more emulsifier(s).

28. The method according to any one of the preceding claims, wherein the temperature of the wsp during step b) is at most 60 degrees C., more preferably at most 55 degrees C., even more preferably at most 50 degrees C., and most preferably at most 45 degrees C.

29. The method according to any one of the preceding claims, wherein the temperature of the wsp during step b) is in the range of −10 to 60 degrees C., more preferably 0 to 55 degrees C., even more preferably 2-50 degrees C., and most preferably in the range of 2-45 degrees C.

30. The method according to any one of the preceding claims, wherein step b) involves contacting the wsp in solid form with the one or more emulsifier(s) in solid form.

31. The method according to any one of the preceding claims, wherein step b) involves contacting the wsp in solid form with the one or more emulsifier(s) in softened form.

32. The method according to any one of the preceding claims, wherein step b) involves contacting the wsp in solid form with the one or more emulsifier(s) in melted form.

33. The method according to claim 32, wherein step b) involves adding the one or more emulsifier(s) in melted form to the wsp, preferably by spraying the one or more emulsifier(s).

34. The method according to any one of the preceding claims, wherein the temperature of the one or more emulsifier(s) when added in step b) is at least 2 degrees C. higher than the melting temperature of the one or more emulsifier(s), more preferably at least 4 degrees C. higher than the melting temperature of the one or more emulsifier(s), and most preferably at least 10 degrees C. higher than the melting temperature of the one or more emulsifier(s).

35. The method according to any one of the preceding claims, wherein the temperature of the one or more emulsifier(s) when added in step b) is at least 65 degrees C., more preferably at least 70 degrees C., even more preferably at least 75 degrees C., and most preferably at least 80 degrees C.

36. The method according to any one of the preceding claims, wherein the temperature of the one or more emulsifier(s) when added in step b) is in the range of 65 to 200 degrees C., more preferably 70 to 150 degrees C., even more preferably 75-100 degrees C., and most preferably in the range of 75-90 degrees C.

37. The method according to any one of the preceding claims, wherein the temperature of the one or more emulsifier(s) when added in step b) is substantially the same as the temperature of the wsp.

38. The method according to any one of the preceding claims, wherein step b) involves mixing the wsp, and more preferably high shearing mixing, while and/or after the one or more emulsifier(s) are added.

39. The method according to any one of the preceding claims, wherein step b) involves mixing, and more preferably high shearing mixing, while the one or more emulsifier(s) are added.

40. The method according to any one of the preceding claims, wherein the mixing of step b), and more preferably high shearing mixing, is obtained by a rotor-stator-based shearing system, a high shear blade system, or similar equipment.

41. The method according to any one of the preceding claims, comprising step c) of cooling the mixture.

42. The method according to claim 41, wherein the mixture is cooled to a temperature that is at least 10 degrees C. lower than the melting temperature of the one or more emulsifier(s), more preferably at least 15 degrees C. lower than the melting temperature of the one or more emulsifier(s), and most preferably at least 20 degrees C. lower than the melting temperature of the one or more emulsifier(s).

43. The method according to claim 41 or 42, wherein the mixture is cooled to a temperature in the range of −10 to 60 degrees C., more preferably 0 to 50 degrees C., even more preferably 2-40 degrees C., and most preferably in the range of 2-30 degrees C.

44. The method according to any one of the preceding claims, comprising step d) involving particle size reduction, preferably operated to obtain a modified mixture wherein at least 80% w/w of the particles of the mixture have a particle size in the range of 100 micron-1000 micron.

45. The method according to any one of the preceding claims, comprising step d) involving particle size reduction, preferably operated to obtain a modified mixture wherein at least 90% w/w of the particles of the mixture have a particle size in the range of 100 micron-1000 micron.

46. The method according to any one of the preceding claims, comprising step d) involving sifting the mixture, preferably after particle size reduction.

47. The method according to any one of the preceding claims, wherein the method comprises step e) of packaging the obtained product of the method, e.g. the cooled mixture obtained from step c) or the processed mixture obtained from step d).

48. The method according to claim 47, wherein the product obtained from step c) or d) is packaged in a suitable container.

49. An emulsifier powder suitable for cold process gelato, the emulsifier powder comprising:
one or more emulsifier(s),
water-soluble particles comprising a saccharide
optionally, one or more additional ingredient(s)
wherein the one or more emulsifier(s) contribute with 15-45% w/w of the emulsifier powder,
wherein the sum of the wsp and the one or more emulsifier(s) contributes with at least 80% w/w of the emulsifier powder, preferably at least 90% w/w, and
wherein the wsp have a water-solubility of at least 20 g/100 g water at 25 degrees C.

50. The emulsifier powder according to claim 49 obtainable by the method according to one or more of claims 1-48.

51. Use of the emulsifier powder according to claim 49 or 50 as an ingredient in the production of a food product produced using temperatures of at most 60 degrees C., more preferably at most 40 degrees C., even more preferred at most 20 degrees C. and most preferably at most 10 degrees C.

52. The use according to claim 51 wherein the emulsifier powder according to claim 49 or 50 contributes with at least 50% w/w of the total amount of emulsifier of the food product, more preferably at least 70% w/w, even more preferably at least 80% w/w, and most preferably at least 90% w/w of the total amount of emulsifier of the food product.

53. The use according to claim 51 or 52 wherein the emulsifier powder according to claim 49 or 50 contributes with 0.05-4% w/w of weight of the food product, and most preferably 0.10-2% w/w of weight of the food product.

54. A process of producing a food product, preferably without using temperatures higher than 60 degrees C., the process comprising the steps of:
i) mixing the emulsifier powder according to claim 49 or 50 with one or more ingredients to provide a first food composition, and
optionally, ii) processing the first food composition of step i).

55. The process according to claim 54 wherein the production of a food product is performed using temperatures of at most 40 degrees C., more preferably at most 15 degrees C., even more preferred at most 10 degrees C., and most preferably at most 5 degrees C.

56. The process according to claim 54 or 55 wherein the emulsifier powder according to claim 49 or 50 contributes with at least 50% w/w of the total amount of emulsifier of the food product, more preferably at least 70% w/w, even more preferably at least 80% w/w, and most preferably at least 90% w/w of the total amount of emulsifier of the food product.

57. The process according to any one of claims 54-56 wherein the emulsifier powder according to claim 49 or 50 contributes with 0.05-4% w/w of weight of the food product, and most preferably 0.2-2% w/w of weight of the food product.

58. The process according to any one of claims 54-57, wherein the food product is gelato and the production of a food product is performed without using temperatures higher than 15 degrees C., more preferably without using temperatures higher than 5 degrees C.; and
wherein in step i) the emulsifier powder according to claim 49 or 50 is mixed, preferably blended, with one or more ingredients to provide a first food composition, wherein the one or more ingredients may comprise one or more of sucrose, glucose, skimmed milk powder, stabilizer(s), and dairy liquid, such as e.g. cream and/or milk; and
wherein the process comprises step ii) and the processing comprises one or more of:
allowing the first food composition of step i) to age, preferably wherein the first food composition has temperature which is at most 10 degrees C. and for at least 10 minutes, more preferably at most 5 degrees C. for at least 15 minutes,
freezing the first food composition either directly after step i) or after aging, preferably wherein the freezing temperature is in the range of −15 and −25 degrees C., more preferably in the range of −16 to −20 degrees C.

59. A food product obtainable by the process of one or more of claims 54-58.
